(19) United States
(12) Patent Application Publication
(10) Pub. No.: US 2014/0067461 A1
(43) Pub. Date: Mar. 6, 2014

(54) System and Method for Predicting Customer Attrition Using Dynamic User Interaction Data

(71) Applicant: OPERA SOLUTIONS, LLC, JERSEY CITY, NJ (US)

(72) Inventors: Wen Zhang, San Diego, CA (US); Zhenhua Wang, Shanghai (CN); Yan Zhang, San Diego, CA (US); Joseph Milana, San Diego, CA (US)

(73) Assignee: OPERA SOLUTIONS, LLC, JERSEY CITY, NJ (US)

(21) Appl. No.: 14/015,198

(22) Filed: Aug. 30, 2013

Related U.S. Application Data
(60) Provisional application No. 61/695,412, filed on Aug. 31, 2012.

(51) Int. Cl. G06Q 10/06

(52) U.S. Cl. CPC G06Q 10/0635
USPC 705/7.28

(57) ABSTRACT

A method, system and non-transitory computer-readable medium for predicting customer attrition are provided. The method can include executing code to load historical data relating to a customer into a database to create a customer history summary file. The method can include executing code to load daily data relating to the customer into a scoring engine. The method can include programmatically processing, via the scoring engine, at least one of the historical data and the daily data to generate an attrition score. The attrition score can indicate a predictive signal of attrition of the customer.

### CROSS-REFERENCE TO RELATED APPLICATIONS

This application claims the benefit of U.S. Provisional Application Ser. No. 61/695,412 filed on Aug. 31, 2012, the entire disclosure of which is expressly incorporated herein by reference.

### FIELD OF THE INVENTION

The present invention relates generally to systems and methods for improving customer relations. More specifically, the present invention relates to a system and method for predicting customer attrition from an online service provider with a contractual subscription using dynamic user interaction data.

### RELATED ART

In the business world, attention to maintaining customer satisfaction in connection with products and/or services provided by business is paramount. This is particularly true for online service providers. Customer experiences using online service providers can generally be described as follows. First, a customer registers at a website. Next, the customer receives some free service and decides to subscribe with a certain contractual length, e.g., one month, three months, six months, twelve months, and the like, at a certain price for advanced services. Thereafter, the customer uses the services provided through the website for a period of time. Next, the customer decides whether to renew the contract for advanced services before expiration of the contract.

Although some online service providers, e.g., online dating companies and the like, record detailed customer service utilization data, this data has not generally been used to its full potential in predicting customer attrition. In particular, attrition and/or fading models are generally applied in many businesses using Customer Relationship Management (CRM) systems. Often such CRM systems include a single, static model that produces a one-time score for each customer. In some cases, the model score can be regenerated periodically with an update of some time series variables. However, these approaches are generally flawed for businesses with fixed length contractual subscription, flexible cancellation policies, adequate recorded service utilization patterns, and the like, as they generally fail to capture a customer's changing behavior in different periods of the whole subscription lifecycle. Consequently, the approaches currently implemented in the industry are typically not tuned to predict the attrition event early enough, e.g., before customers make decisions to abandon services. Therefore, these approaches generally do not fit well for risk mitigation.

Thus, a need exists not only for accurately predicting customer attrition, but also predicting attrition in such a manner that can predict the attrition event early enough in order for a service provider to intervene and/or save the customer. In particular, a need exists for predicting customer attrition so as to allow for targeted treatment opportunities to retain customers for a longer period of time. These and other needs are satisfied by the exemplary systems and methods disclosed herein.

### SUMMARY

The present invention relates to a system and method for predicting customer attrition using dynamic user interaction data. The system allows a user to load customer data into a database, processes the customer data using a scoring engine to calculate one or more attrition scores, and outputs and transmits the attrition scores to the user prior to expiration of a subscription of the user in order to increase a likelihood of renewal of the subscription by the user. The attrition scores can be utilized to predict customer attrition early and allow for a timely intervention to save a customer.

### BRIEF DESCRIPTION OF THE DRAWINGS

The foregoing features of the invention will be apparent from the following Detailed Description of the Invention, taken in connection with the accompanying drawings, in which:

FIG. 1 is a flowchart showing overall processing steps carried out by the system;

FIG. 2 is a diagram showing software components of the system;

FIG. 3 is a graph showing an average attrition rate and a 7-day hazard rate trend by days since subscription;

FIGS. 4A and 4B are graphs showing hidden attrition patterns captured by the system from communications;

FIG. 5 is a graph showing ROC curves of static and dynamic attrition models of the system;

FIG. 6 is a graph showing a daily test model of the system simulated as a production environment;

FIG. 7 shows examples of predicted attrition scores, reason codes and a bubble chart generated by the system for illustrating user behaviors;

FIG. 8 shows an exemplary user interface generated by the system for displaying attrition scores and other information; and

FIG. 9 is a diagram showing exemplary hardware and software components of the system.

### DETAILED DESCRIPTION OF THE INVENTION

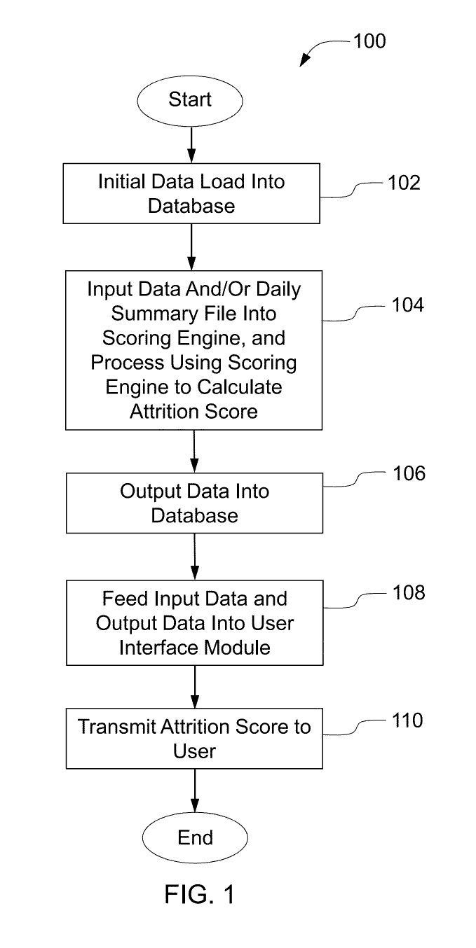

The present invention relates to a system and method for predicting customer attrition using dynamic user interaction data, as discussed in detail below in connection with FIGS. 1-9.

Attrition modeling is widely applied in various industries. For businesses with contractual subscriptions, flexible cancellation policies, detailed customer service utilization data, and the like, the present disclosure provides an exemplary system and method for predicting and/or tracking customer attrition behaviors. The exemplary system and method disclosed herein provides the following features, among others: (1) population (customer) segmentation by subscription type and length; (2) an event of turning off auto renew is regarded as the attrition decision making signal in model development; (3) a short term hazard rate is predicted and treated as a target variable; (4) attrition signals from dynamic utilization data are generated from up-to-date user service utilization data to capture subtle customer behavior patterns and changes, including the comparison of customers with other users; (5) models are built for segmented user groups and distributed over time (e.g., days) and/or segments since subscription, over time of subscription, and the like, targeting various attrition behaviors at different stages of the subscription; (6) reason codes can be generated based on clustering of variables and/or visualized with a combination of score trends and/or a graphical chart of service utilization patterns; and (7) a production system implementing the steps described below can be utilized. The system disclosed herein thereby allows the capture of attrition signals early and, with the intuitive visualization design, provides the opportunity to intervene substantially on the spot.

FIG. 1 is a flowchart showing overall processing steps 100 carried out by the system. Beginning in step 102, an initial data load of customer data is made into a database, e.g., a client database. This step loads all historical data related to a scoring population in order to create a customer history summary file. A user can extract the required daily input file data from the database, if desired. In step 104, daily data related to the scoring population, a daily summary file, and other information, can be input into a scoring engine, and the customer data and, optionally, daily data, is processed by the scoring engine to calculate an attrition score. In step 106, after the scoring engine completes processing of the input data, it generates an output data file and updates the daily summary file. This output data can further be output into the database and/or integrated into the database by the user, if desired. Based on, for example, the historical data relating to a scoring population in the database, predictive signals of attrition can be created. In step 108, the input data and/or the output data can be transmitted to a user interface module (e.g., prior to expiration of a subscription of the user (customer) in order to increase a likelihood of renewal of the subscription by the user). Finally, in step 110, an attrition risk score, reason codes, and a raw service utilization pattern are transmitted to the user using the user interface module.

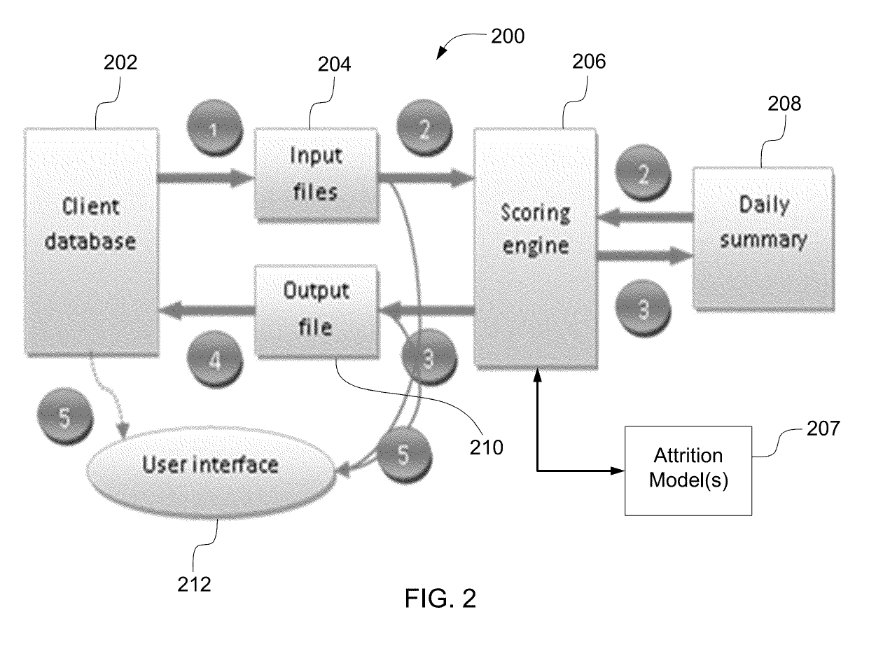

FIG. 2 is a diagram showing software components of the system, indicated at 200, as described herein. The components 200 include a client database 202, an input file 204, a scoring engine 206, a daily summary 208, an output file 210, and a user interface 212. The system can be considered a file-based implementation system. Steps 1-5 shown in FIG. 2 substantially correspond to the steps illustrated in FIG. 1. In particular, step 1 and step 2 correspond to step 102 and step 104, steps 3 and 4 correspond to step 106, and step 5 corresponds to steps 108 and 110. The dashed line of step 5 shown in FIG. 2 illustrates that the client database 202 can be directly accessed by the user interface 212. In particular, since data from both the input file 204 and the output file 210 can be found in the database 202, the user interface 212 can optionally directly query data from the database 202. Steps 1 and 4 of FIG. 2 could be eliminated by integrating the scoring engine 206 into the database 202. The scoring engine 206 includes one or more attrition models 207, discussed below, which are applied by the scoring engine 206 to calculate an attrition risk score for the customer data.

An important aspect of the system and associated methods disclosed herein includes population segmentation. Although it is tempting to build a single model that covers all subscribed users, the entire population consists of groups with drastically different behaviors in business involving contractual subscriptions. Thus, population segmentation, i.e., customer segmentation, should be implemented. In general, there are at least three major user groups: (1) first time subscribers, (2) re-subscribers, and (3) renewal customers. Among each group, there are generally different contractual subscription periods. Thus, the attrition behavior of these groups is significantly different from each other, making a one-model-fit-all approach inadequate. Although the population segmentation described herein focuses on three month initial subscribers, in other embodiments, the exemplary methodology can be applied to different population segments.

An additional aspect of the system and associated methods disclosed herein includes an attrition decision time identification. Attrition is typically identified when a customer does not renew a service previously utilized. However, customers generally do not wait until the last moment to make the decision not to renew the service. For example, customers usually stop using the service in the middle of the contract. Thus, any customer service utilization data obtained after the decision was made generally leads to label leakage. Moreover, once the attrition decision has already been made, it is generally difficult to change. Therefore, it is important to predict the attrition event before the customer actually makes the decision.

The auto-renewal for a service contract is typically set to “on” by default by online service providers. When a customer actually turns the auto-renewal feature off in the middle of the subscription, it is a strong indicator that the attrition decision was made. This event can be called Renewal Turn-Off. For example, based on data obtained from an online dating company, about 98% of the customers who had a renewal turn-off event actually attrited, while all those who did not have a renewal turn-off event renewed their service contract. Therefore, all data after a renewal turn-off event should generally be ignored to avoid label leakage.

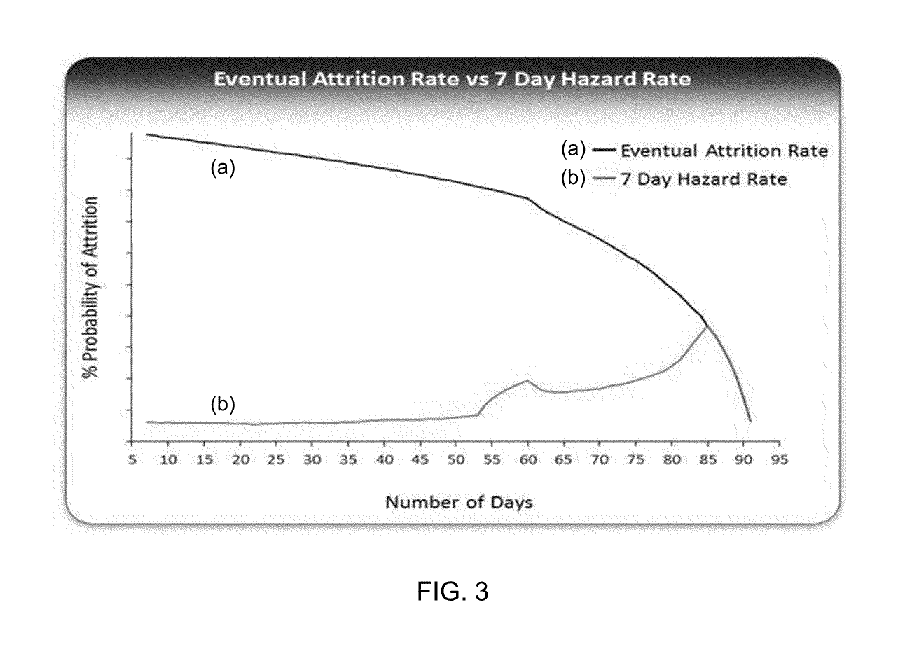

Another aspect of the system and associated methods disclosed herein includes an attrition target label. The exemplary attrition model discussed herein can be run on a daily basis to meet the business needs of timely intervention. To construct the model-building dataset, an attrition label should be assigned to each data record. In some exemplary embodiments, all records of a user may be labeled as positive, as long as the user has a renewal turn-off event anytime during the subscription. In this situation, the eventual attrition rate should be a monotone decreasing function, as shown by the exemplary real data represented by curve “a” in FIG. 3.

The attrition event can be predicted by the system with a defined time window, e.g., whether or not a customer is going to have a renewal turn-off event within the next seven days. Data collected indicates that greater attrition and/or renewal decisions are made closer to the end of a subscription period. Thus, the “7-day hazard rate” generally increases as a function of time, as shown by curve “b” in FIG. 3. This definition clearly indicates the instantaneous attrition risk. Further, there is generally no reason for a customer to behave like an attritor from the beginning of the subscription. Specifically, a user will generally make a decision only when the user has accumulated enough experience/evidence, good or bad, with the provided service. Therefore, a defined period, e.g., about seven days, before the renewal turn-off event is labeled by the system as positive data points. The defined period can be any desired number of days.

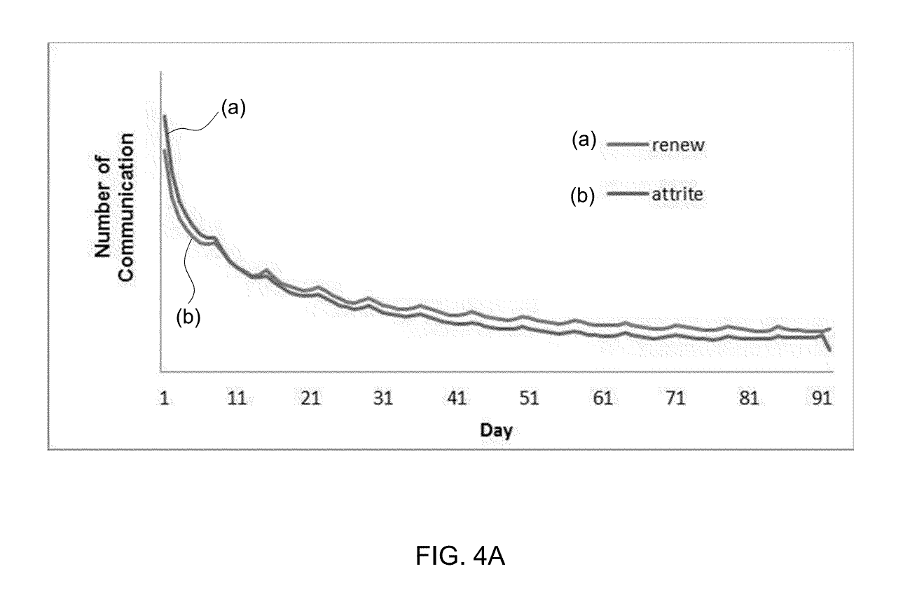

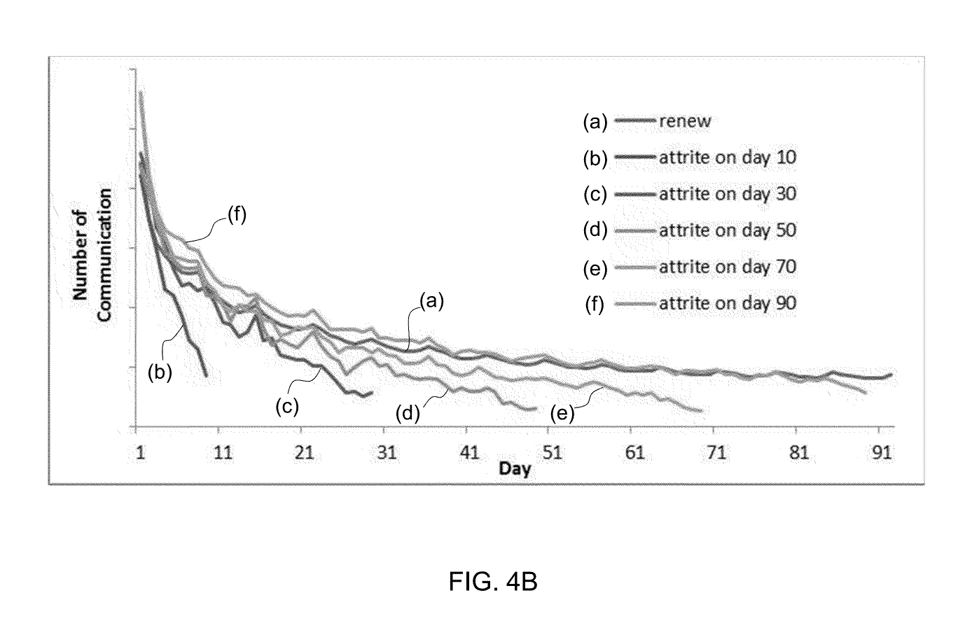

FIG. 4A shows attrition patterns captured by the system from communications. The average number of communications of renewed and attrited users are generally similar if all days of attrited customers are labeled as “1”, i.e., there is generally no observed difference between the average communications of attrited and renewed users. With respect to FIG. 4B, a greater drop in communication levels for attrited customers a few days ahead of a renewal turn-off event is observed if the attrited customers are separated/segmented by day and/or date of a renewal turn-off event, e.g., with attrition occurring on day 10, 30, 50, 70 and 90. In particular, it can be seen from FIG. 4B that while the attrited and renewed users behaved substantially similarly in the starting phase of their subscription period, the attrited users generally have significantly less communications than the renewed population only a few days before a renewal turn-off event. This clear separation assists in detecting customer attrition.

Another aspect of the system and associated methods disclosed herein includes the use of variables to categorize user profiles and behaviors. These variables can form part of the models implemented by the scoring engine of the system. At least two major categories of variables can be generated, e.g., static variables, dynamic variables, and the like. In general, static variables includes user profile information which rarely changes during the entire subscription lifecycle of the user. In contrast, dynamic variables are those that reflect the user's experience and/or behavior at different stages of the entire lifecycle. The generation of dynamic variables typically requires the processing of time series data to capture various patterns and/or signals. The captured patterns and/or signals from dynamic variables can be implemented by the system.

Exemplary dynamic variables can include, e.g., service utilization quantity measures, ratio variables, peer comparison variables, self-comparison variables, and the like. Although the exemplary dynamic variables discussed herein are provided for an online dating service provider, those of ordinary skill in the art should understand that alternative dynamic variables can be implemented based on the type of service provider utilizing the system.

For an online dating service provider, service utilization quantity measures can include, e.g., the number of matches, communications, successful matches, and the like. The users of such clients constitute a special type of social network. Thus, matches and/or communications can be regarded as lines between different vertices that represent users. Further, these variables generally indicate the degree of each vertex. More advanced features, e.g., a loop count, and the like, may also be derived from these networks.

Ratio variables can include, e.g., a response rate, an acceptance rate, a success rate, an effective match rate, and the like. These variables capture the interaction between variables and can bring deeper business insights. In particular, the guided communications on an exemplary online dating service platform provide interesting and/or useful user behavior patterns and/or hidden information regarding user experiences. For example, users generally go through a number of steps. The success rate can therefore be measured as the number of final-stage communications a user has reached divided by total first stage communications.

Peer comparison variables, e.g., group normalization variables, can measure the engagement level of a customer relative to other customers. For example, the user experience can be normalized by the average of renewed population in the same subscription period. This is important because users tend to use a service more intensively in the beginning phase and then decrease the amount of use of a service as time passes. For example, receiving three matches in day ten is fundamentally different from receiving three matches in day eighty. Thus, absolute value is generally less meaningful than ratio variables. To compensate for this, a renewal population may be utilized as a benchmark in the normalization. Therefore, a value of 0.8 can mean that the value is 80% of the renewal population average.

Self-comparison variables generally measure the engagement level of a customer compared with one's own longitudinal history. People are intrinsically different from each other. Some people are more proactive, while others are more conservative. Thus, the same amount of utilizations from proactive users has different ramifications than from a more passive user. The system can normalize dynamic variables by the customer's historical information. For example, the most recent engagement level of a customer may be compared with the historical average. In some exemplary embodiments, normalization with a customer's most active engagement level may be implemented.

As discussed above, the system and associated methods disclosed herein include one or more attrition models. For example, a segmented and distributed model may be implemented to address varying attrition behavior for different segments of a subscription and over time. Clustering methods can also be utilized to reveal detailed user segmentations. As an example, gender will be used to segment the user population. A traditional approach is to build one single model for each segment. This approach has several disadvantages in that, e.g., it requires a complex normalization of variables over the subscription period, it does not provide the flexibility to tailor predictive variables for different stages of a subscription, and the like.

Rather than building a single model, the system can construct a series of models distributed over time. In particular, a designated model should be built for each day of a subscription. With the model distributed over time, the predictive power can be optimized based on the number of days since subscription. Further, different variable sets can be utilized at various stages of a subscription period. Variable selection of a model generally indicates that the number of commutations initiated was predictive in the early stages and became less so in later stages based upon which website activity and/or life cycle completeness became more significant. This is further discussed and confirmed below with respect to the exemplary results of reason code distribution.

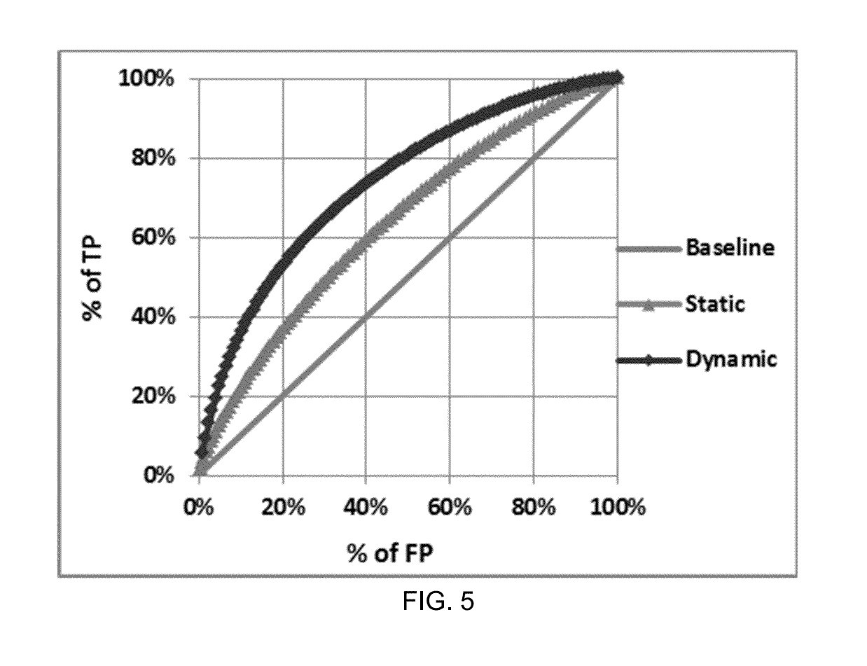

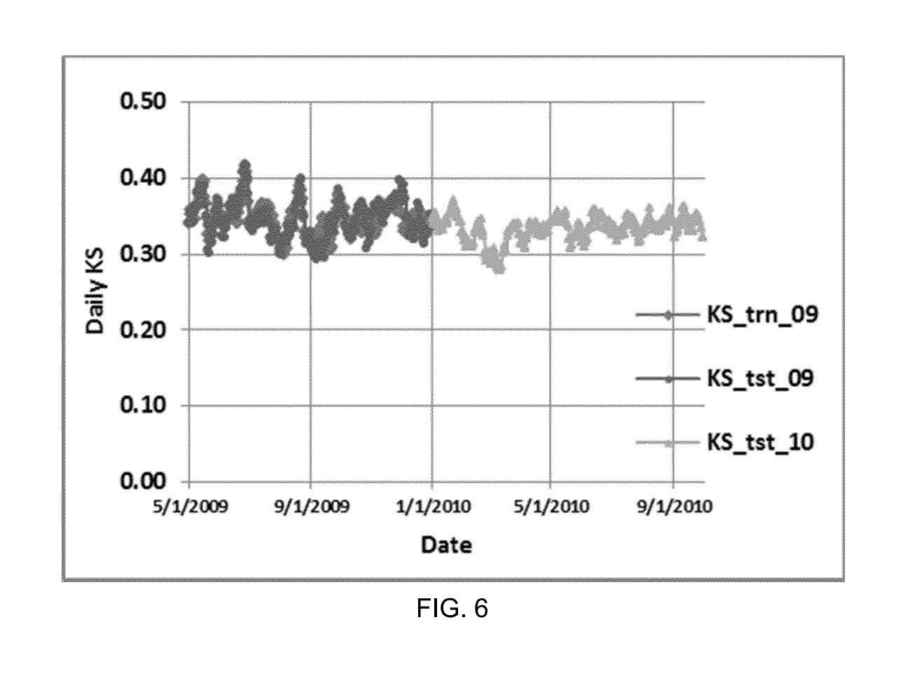

With reference to FIG. 5, the receiver operating characteristic (ROC) curves of static and dynamic attrition models of the system are provided. As can be seen from FIG. 5, the distributed model framework and multi-dimensional variables created from dynamic utilization data generally improve a model of a test group. FIG. 6 shows daily tests of the model simulated to represent an actual production environment, including out-of-sample and out-of-time tests performed and their results. The results shown in FIG. 6 generally indicate that any potential over-fitting is well controlled.

An additional feature of the system and associated methods disclosed herein includes reason code generation and/or visualization. Reason codes provide an explanatory guide to the end-users of the system. The reason codes of the system can be based on variable clustering and/or business consideration. Exemplary reason codes can be, e.g., login activity, active service engagement activity, passive service engagement activity, positive experiences, negative experiences, price sensitivity, service quality, and the like.

In an online dating service example, eight reason codes were implemented by the system, as shown in Table 1 below. In particular, Table 1 shows the reason code distribution by month of a life cycle. All variables selected by the model were divided into the eight categories and each category indicates a distinct reason why the model generated a high score. In different periods of a user's life cycle, different reasons generally contribute to a higher-than-average score. Table 1 also shows the distribution of top reason codes across the user life cycle, which can offer, e.g., business directional guidance for a marketing campaign.

TABLE 1

| REASON | MONTH1 | MONTH2 | MONTH3 |
|---|---|---|---|
| WEB ACTIVITY | 19.73% | 36.48% | 47.21% |
| MATCH QUANTITY | 14.68% | 11.89% | 16.44% |
| SUBSCRIBED | 5.78% | 2.02% | 1.40% |
| MATCHES | | | |
| SENDING ACTIVITY | 37.17% | 31.74% | 15.55% |
| RECEIVING | 3.26% | 1.98% | 4.10% |
| ACTIVITY | | | |
| LIFECYCLE | 0.25% | 1.21% | 1.14% |
| COMPLETE | | | |
| PRICE/INCOME | 9.31% | 6.89% | 10.06% |
| PHOTO/ABOUT ME | 9.83% | 7.78% | 4.10% |

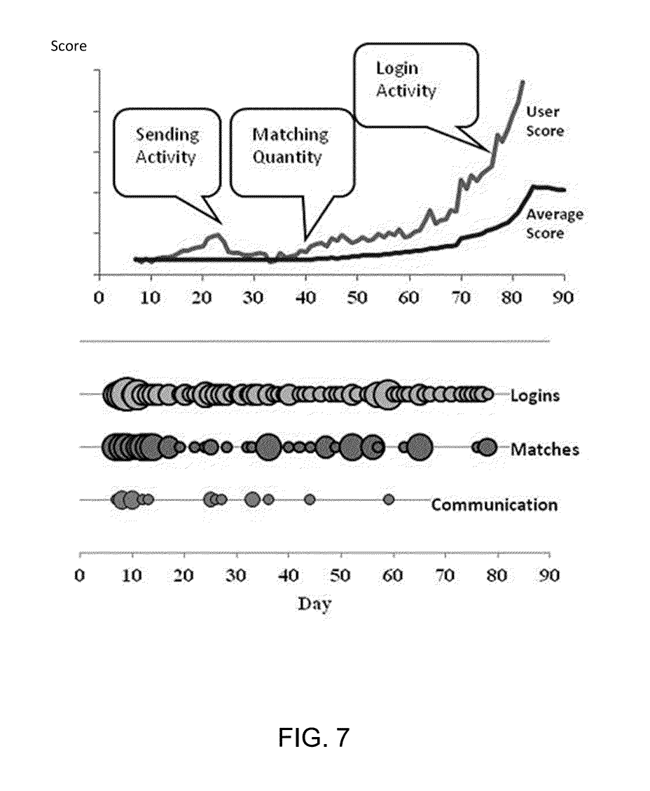

FIG. 7 illustrates the score trend by day for an attrited customer. A bubble chart may be used to visualize the service utilization pattern together with a prediction score and reason code. It should be understood that the size of the bubble illustrated in the bubble chart of FIG. 7 is proportional to the service utilization intensity. This combination provides a unique power for understanding attrition prediction. In the example depicted in FIG. 7, the first high score can be seen on approximately Day 20 with a reason code of “Sending Activity”. With the help of the bubble chart, one can recognize the actual decrease of sending activity. After Day 20, the score returns to average when some sending activity occurs. The second high score can be seen on approximately Day 40 due to a drop in the number of matches, visualized by a reason code of “Matching Quantity”. The score stays slightly above average after Day 40. On approximately Day 70, the score suddenly increases due to decreased logins, visualized by a reason code of “Login Activity”. As can be seen in FIG. 7, the score continues to rise after Day 70 until attrition occurs on Day 83.

The score trend and bubble chart of FIG. 7 provide important information which enables a business to intervene at the right time, i.e., prior to customer attrition, and with the right strategy, to potentially save the customer. In the example above, the business can, e.g., send a reminder to the user when the first sign occurs on approximately Day 20. When the second sign occurs and “Matching Quantity” appears as a reason code, the business can respond by, e.g., sending more matches to the user by relaxing the matching criteria or by a different method.

A sample output format generated by the system is provided in Table 2 below. The sample output can include, e.g., a user ID, days since subscription, a predicted probability value, a relative risk value, a precision value, an indication of at least one reason code, and the like.

TABLE 2

| | |
|---|---|
| User ID | 19007591 |
| Days Since Subscription | 74 |
| Predicted Probability | .155 |
| Relative Risk | 1.96 |
| Precision | .177 |
| Reason Code 1 | 1—Website Activity |
| Reason Code 2 | 4—Sending Activity |
| Reason Code 3 | 2—Match Quantity |

As discussed previously, the two stages of the system include an initial data load stage and a daily scoring engine processing stage. In the exemplary process described above, the daily summary file summarizes the customers' historical information, thereby generating the “DNA” for each customer. To improve robustness, a copy of a current summary file can be made before it is updated. Also, to make the daily scoring more efficient, an exponentially decaying weighted moving average (EWMA) technique can be applied instead of a regular moving average for those service count signals, i.e., dynamic signals, previously discussed. The exemplary EWMA technique can be represented by Equation 1 below:

EWMAₙ=EWMAₙ₋₁*k+sample*(1−k) Equation 1

where k is a decay factor. The EWMA technique does not require the scoring of historical data. Rather, the EWMA technique only requires storing the current EWMA and updating data based on the most recent EWMA. This generally improves the solution time efficiency and the space efficiency of the system.

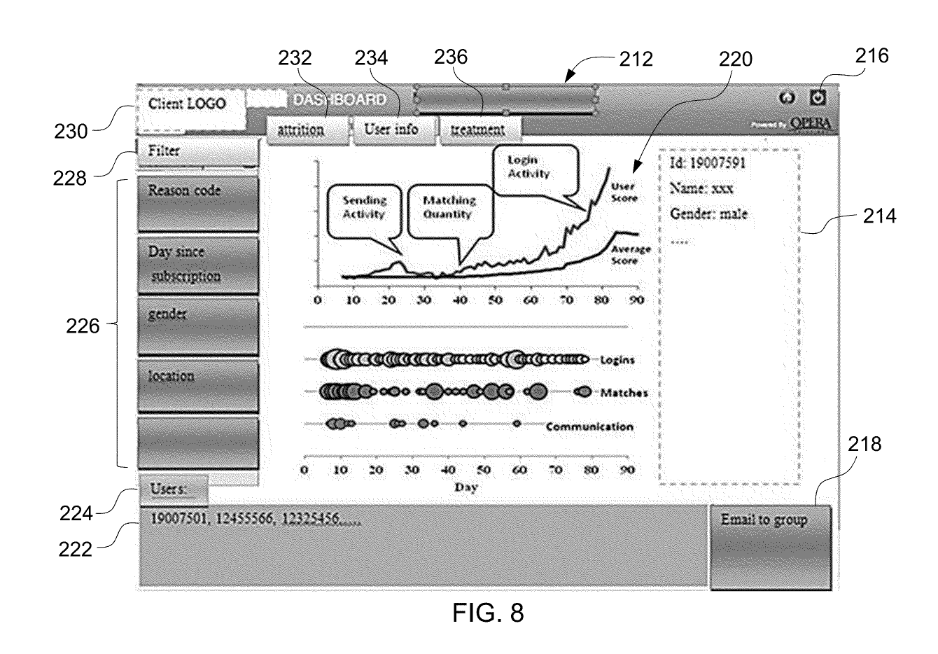

FIG. 8 shows an exemplary user interface 212 generated by the system. The user interface 212 can include an on/off button 216, a client logo area 230, and may be accessed through, e.g., a website, an Internet connection, and the like. The user interface 212 can include a user information display 214 which shows detailed information about a particular user of interest. For example, the user information display 214 can include a user ID, a user name, a user gender, and the like. A users button 224 can also be implemented to display and/or select users from a user display 222. For example, the users button 224 and/or the user display 222 may be implemented to select and/or compare a plurality of users at the same time or select a particular user of interest. The user interface 212 can further include an email to group button 218 for emailing desired information, e.g., data, charts, and the like, to other users and/or clients.

Still with reference to FIG. 8, the user interface 212 can include a filter 228 for filtering data being displayed and/or analyzed based on the desired filter data 226. In particular, the filter data 226 can include, e.g., a reason code, a day since subscription, a gender, a location, and the like. Based on the selected filter data 226, the visual display area 220 can be varied to conduct the proper analysis of the data collected. The visual display area 220 can include at least one chart, e.g., a predicted attrition score and reason code chart, a bubble chart, and the like. The at least one chart can include charts substantially similar to those displayed in FIG. 7. The user interface 212 can further include an attrition selection tab 232, a user information selection tab 234, and a treatment selection tab 236, which can be implemented to select the type of visual display and/or data to be shown and/or analyzed by the user interface 212, e.g., attrition data, user information data, treatment data, and the like.

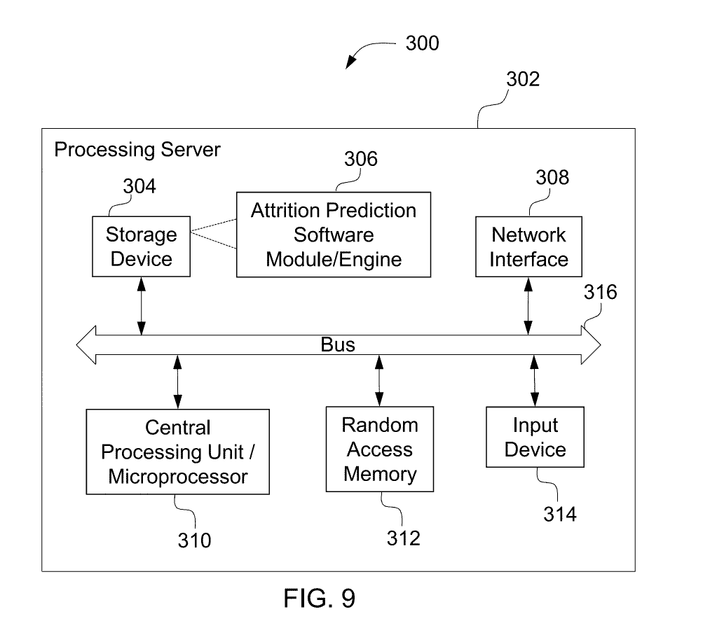

FIG. 9 is a diagram showing hardware and software components of the system, indicated at 300, capable of performing the processes discussed above. The system 300 includes a processing server 302, a storage device 304, a network interface 308, a communications bus 316, a central processing unit (CPU) 310, e.g., a microprocessor, and the like, a random access memory (RAM) 312, and one or more input devices 314, e.g., a keyboard, a mouse, and the like. The processing server 302 can also include a display, e.g., a liquid crystal display (LCD), a cathode ray tube (CRT), and the like. The storage device 304 can include any suitable, computer-readable storage medium, e.g., a disk, non-volatile memory, read-only memory (ROM), erasable programmable ROM (EPROM), electrically-erasable programmable ROM (EEPROM), flash memory, field-programmable gate array (FPGA), and the like. The processing server 302 can be, e.g., a networked computer system, a personal computer, a smart phone, a tablet, and the like.

The present invention can be embodied as an attrition prediction software module and/or engine 306, which can be embodied as computer-readable program code stored on the storage device 304 and executed by the CPU 310. The engine 300 could be programmed using any suitable, high or low level computing language, such as, e.g., Java, C, C++, C#, .NET, and the like. The network interface 308 can include, e.g., an Ethernet network interface device, a wireless network interface device, any other suitable device which permits the processing server 302 to communicate via the network, and the like. The CPU 310 can include any suitable single- or multiple-core microprocessor of any suitable architecture that is capable of implementing and/or running the attrition prediction engine 306, e.g., an Intel processor, and the like. The random access memory 312 can include any suitable, high-speed, random access memory typical of most modern computers, such as, e.g., dynamic RAM (DRAM), and the like.

Having thus described the invention in detail, it is to be understood that the foregoing description is not intended to limit the spirit or scope thereof. It will be understood that the embodiments of the present invention described herein are merely exemplary and that a person skilled in the art may make any variations and modification without departing from the spirit and scope of the invention. All such variations and modifications, including those discussed above, are intended to be included within the scope of the invention.

1. A method of predicting customer attrition, comprising:
loading historical data relating to a customer into a database to create a customer history summary file,
loading daily data relating to the customer into a scoring engine executing on a computer system, and
processing, using the scoring engine, at least one of the historical data and the daily data to generate an attrition score; and
transmitting the attrition score to a user of the computer system prior to expiration of a subscription of the customer in order to increase a likelihood of renewal of the subscription by the customer.

2. The method according to claim 1, wherein the daily data includes data relating to at least one of a scoring population and a daily summary file.

3. The method according to claim 1, comprising generating an output data file and updating the daily data relating to the customer based on the output data file.

4. The method according to claim 1, wherein the attrition score is at least one of an attrition risk score, a reason code, and a raw service utilization pattern.

5. The method according to claim 1, comprising transmitting the attrition score to the user via a user interface.

6. The method according to claim 1, wherein the scoring engine is integrated into the database.

7. The method according to claim 1, wherein the score engine comprises at least one attrition model to calculate the attrition score for the customer.

8. The method according to claim 7, wherein the attrition model is at least one of a segmented model, a distributed model, a clustering model, and a series of models distributed over time.

9. The method according to claim 1, comprising segmenting a customer population into at least one of (i) first time subscribers, (ii) re-subscribers, and (iii) renewal customers.

10. The method according to claim 1, comprising processing at least one of the historical data and the daily data to identify an attrition decision time.

11. The method according to claim 1, comprising assigning an attrition target label to at least one of the historical data and the daily data.

12. The method according to claim 1, comprising categorizing a profile and a behavior of the customer by assignment of at least one of a static variable and a dynamic variable.

13. The method according to claim 12, wherein the static variable includes profile information of the customer.

14. The method according to claim 12, wherein the dynamic variable includes at least one of service utilization quantity measures, ratio variables, peer comparison variables, and self-comparison variables.

15. The method according to claim 1, comprising generating a reason code for providing an explanatory guide to the generated attrition score.

16. The method according to claim 15, wherein the reason code is at least one of login activity, active service engagement activity, passive service engagement activity, a positive experience, a negative experience, price sensitivity, and service quality.

17. A non-transitory computer-readable medium storing instructions, wherein execution of the instructions by a processing device causes the processing device to execute the steps comprising:
loading historical data relating to a customer into a database to create a customer history summary file,
loading daily data relating to the customer into a scoring engine executing on a computer system, and
processing, using the scoring engine, at least one of the historical data and the daily data to generate an attrition score; and
transmitting the attrition score to a user of the computer system prior to expiration of a subscription of the customer in order to increase a likelihood of renewal of the subscription by the customer.

18. A system for predicting customer attrition, comprising:
a computer system including a storage device storing electronic data representative of historical data relating to a customer representing a customer history summary file,
a user interface, and
a scoring engine executed by the computer system and configured to (i) receive daily data relating to the customer, and (ii) process at least one of the historical data and the daily data to generate an attrition score prior to expiration of a subscription of the customer in order to increase a likelihood of renewal of the subscription by the customer.

19. The system according to claim 18, wherein the user interface includes a score trend and a bubble chart.

20. The system according to claim 18, wherein the scoring engine is configured generate an output file, the output file including at least one of a user identification, days since subscription, a predicted probability value, a relative risk value, a precision value, and an indication of at least one reason code.
